(19) United States
(12) Patent Application Publication
(10) Pub. No.: US 2007/0267816 A1
(43) Pub. Date: Nov. 22, 2007

(54) Real-time response over hardware I/O interfaces for video gaming machine

(75) Inventor: Byron W. Goodman, Frisco, TX (US)

Correspondence Address: Byron W. Goodman;Suite 240, 3102 Maple Avenue, Dallas, TX, 75201, US

(73) Assignee: IHSoft, Ltd., Frisco, TX (US)

(21) Appl. No.: 11/438,035

(22) Filed: May 22, 2006

(51) Int. Cl. A63F 3/08; A63F 13/00

(52) U.S. Cl. 273/274; 463/1

(57) ABSTRACT

Video gaming systems for wagering are usually required to interact through hardware I/O (Input/Output) interfaces with peripherals and other external systems. Often, the interaction includes real-time requirements which are not easily met when using preemptive multitasking operating systems, such as Microsoft's Windows. By combining various features of the operating system, it is possible to provide real-time responses while still maintaining the performance of the video game itself.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

1. Field of the Invention

The present invention relates to video gaming equipment, particularly to video gaming systems for wagering that employs a computer with preemptive multitasking Operating Systems and Input/Output requirements which include real-time constraints.

2. Description of the Prior Art

Video gaming machines for wagering have been widely adopted by the gaming world as the successor to the traditional, reel-based, mechanical slot machine. The term “gaming”, as used herein, indicates that some form of wagering is occurring in the form of currency or an equivalent, e.g. tokens or credits.

The most basic purpose of a gaming apparatus is to display a randomly generated result and its associated payout. Currently, video gaming systems vary greatly in the way they generate the actual representation of the game and its associated result. At any given time, casinos can host hundreds of different games with equally varied features

Gaming machines do have some commonality. Most of them contain peripheral hardware systems that communicate with the computer based control system through I/O interfaces. These peripherals include buttons, touch screens, credit management devices, coin acceptors, currency acceptors, card readers, and security devices. Most gaming machines also employ I/O interfaces to communicate with external systems, such as accounting systems or casino computers.

IO or I/O means Input/Output, such as any hardware interface to a computer which provides a method of sending and receiving data. Some examples are serial ports, parallel ports, USB, Ethernet, and IEEE 1394 (also known as Firewire).

Some of the protocols defined for I/O communication between the computer and the peripherals or external systems dictate real-time requirements. That is, a deadline between a communications event and its response. Meeting these requirements with commercial preemptive multitasking operating systems such as Microsoft's Windows and Linux variants can be challenging.

Computer means a personal computer or embedded system which includes a motherboard capable of loading commercial operating systems such as Microsoft Windows and Linux/Unix variants.

Peripheral means any hardware or software device which communicates with the game machine computer through hardware I/O interfaces.

External system is used to represent any complex external system which, while not necessarily a peripheral, still employs hardware I/O interfaces to communicate with the game machine computer. One example would be casino back-end accounting systems.

Real-time is used to define operations where the combined reaction-time and operation-time of a task must be shorter than some maximum delay.

OS means operating system, such as in any commercial operating system like Microsoft Windows and Linux/Unix variants.

Preemptive multitasking operating system is an OS which allows the computer system to guarantee each application process a regular “slice” of operating time.

Threads are application processes in a computer which run in the same memory space. They are provided by most commercial preemptive multitasking operating systems.

Asynchronous I/O is a form of input/output processing which allows I/O operations to occur without the need for the application execution to pause while waiting for completion of the operation.

Video gaming machines are now employing computers with commercial operating systems to execute game content, control peripherals and communicate with external systems. Modern computers provide execution and video performance never before seen in this market, which has lead to a wealth of new ideas relating to video gaming.

### BRIEF SUMMARY OF THE INVENTION

This invention employs various features available in preemptive multitasking operating systems which, when used in concert, provide a means of meeting real-time requirements while maintaining the performance of modern video gaming system, specifically those with heavy video requirements.

### BRIEF DESCRIPTION OF THE SEVERAL VIEWS OF THE DRAWING

These and other objects of the present invention will become evident from the following illustrations:

FIG. 1 is a block diagram showing an abstract representation of the components commonly present in a gaming apparatus which are relevant to this invention.

FIG. 2 is a graphical representation of an example of a I/O communication delay.

FIG. 3 is a diagram representing portions of the internal design of the software application which are relevant to this invention.

FIG. 4 is a more detailed representation of a subsystem represented in FIG. 2, the portions shown are those specifically relevant to this invention.

### DETAILED DESCRIPTION OF THE INVENTION

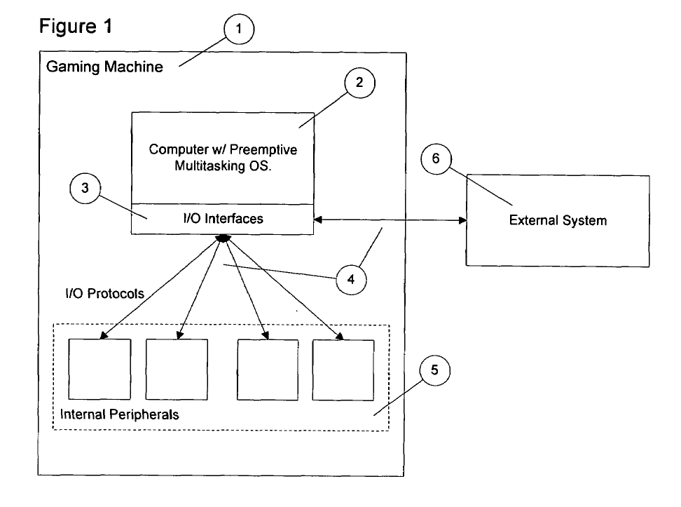

FIG. 1 shows a video gaming machine (1) with a computer based system (2) which employs a preemptive multitasking operating system. The game application is executed by the OS. The OS, provides the application with software interfaces to the hardware I/O interfaces (3). The application employs these interfaces to communicate with internal peripherals (5), such as currency acceptors, card readers, printers, security devices, etc. It also communicates with external systems (6), which may take the form of casino accounting systems, player tracking systems, casino computers, etc. The communication through the I/O interfaces to each target usually includes a device or system specific protocol (4). The adoption of computer platforms and operating systems like the one in FIG. 1, has introduced latencies or delays inherent in these systems when using them to interact with hardware though standard I/O interfaces. The delays can become problematic when real-time requirements are present as part of the communication protocols employed to interact with peripherals or external systems.

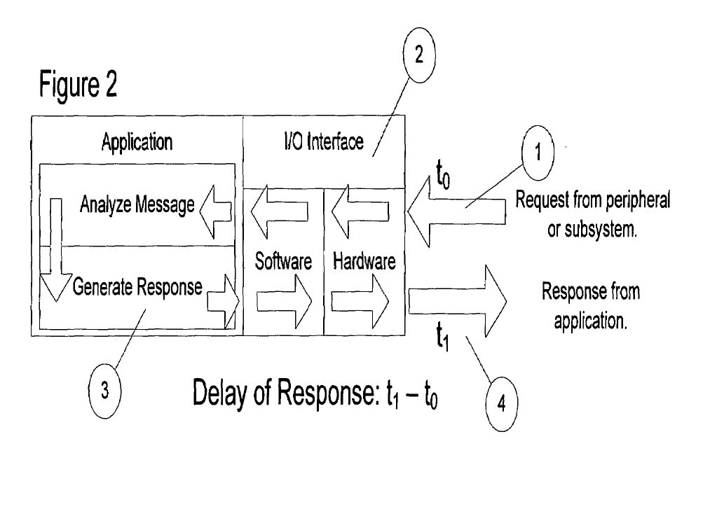

FIG. 2 shows an example of the delay in response intrinsic in this type of system. A peripheral or external system makes a request to the application over an I/O interface (1). The hardware and software portions of the I/O interface have a certain amount of latency involved in the handling of the actual transmission (2). Once the application detects the I/O transaction, it must analyze, execute and respond to it (3). Once a response is formulated, it is transmitted back to the originating system through the same I/O interface (4). The delay in the response is shown as t₁−t₀, or the difference between the time of request and the time of response. If the transaction includes a real-time constraint, the time of response must be less than the constraint. This invention defines a method through which I/O and OS latencies are significantly reduced in order to meet real-time requirements without a significant negative effect on the overall performance of the computer, specifically its video performance. This is achieved by combining software design, threads, data caching and asynchronous I/O.

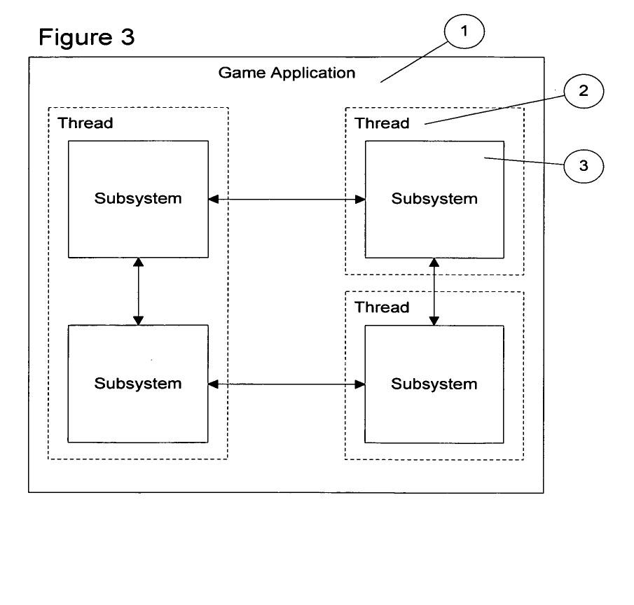

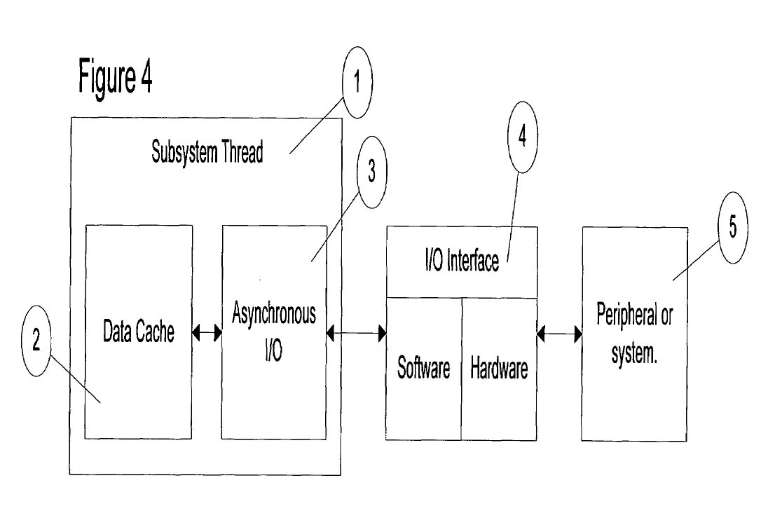

FIG. 3 demonstrates, in a simplified way, how the game application (1) is designed in order to tackle the I/O performance issues. The various subsystems within an application (3) are assigned to threads of execution (2) depending on their functionality. Threads are a way for an application to split itself into multiple tasks but share a memory space. The priority of the each thread is chosen to reflect how time-critical the execution of the subsystem is. The majority of the application will be executed with normal priority, but subsystems which include I/O interaction and are burdened with real-time constraints are set to higher priorities of execution. Employing threads in this way constitutes the first portion of the present invention. The usage of threads, by themselves, is usually not enough to meet real-time constraints. How the subsystem is developed is a critical part of this invention. A subsystem which is set to a high priority of execution might consume CPU cycles to the detriment of other aspects of the application. This is avoided by applying design constraints to the subsystem. FIG. 4 represents the interaction between a subsystem (1) and a peripheral (or external system) with real-time I/O requirements (5). It is necessary for the subsystem to react in a timely manner to any incoming message. This is attained by setting the priority of the thread for the subsystem as explained above. To minimize the effect of the threaded subsystem on other parts of the application, asynchronous I/O operations are employed (3). Asynchronous I/O processing is a from of input/output processing which allows I/O operations to occur without pausing execution to wait for completion of the operation. This enables the subsystem to carry out I/O operations without preventing the rest of the application from executing.

The combination of threads and asynchronous I/O allow subsystems to detect and handle I/O transmissions in a timely manner. But the execution time of the analysis and response to the transaction contributes to the overall delay of response. Therefore, a subsystem design must be further constraint in the amount of time it can take to generate a response. Since the subsystem is already in a high priority thread of execution, it will be given priority over other aspects of the application. But if formulating a response involves any type of interaction with hardware, such as when non-volatile storage is involved, a method of caching data must be provided. Any data not readily available to the subsystem should be locally cached to ensure that the subsystem will be able to generate a response within its real-time constraint.

The invention claimed is:

1. A computer based video gaming system for wagering which employs a preemptive multitasking operating system to control a plurality of computerized wagering games and their associated hardware, wherein said system interacts through hardware I/O interfaces with its own hardware peripherals and/or external systems.

2. The gaming system of claim 1 wherein a preemptive multitasking operating system (OS), such as Microsoft's Windows and UNIX derivatives, is used to execute the video game software.

3. The gaming system of claim 1 wherein any of its peripherals or external systems introduce a real-time constraint to I/O interactions, where real-time constraint is defined as operational deadlines from an event to a response from the system.

4. The gaming system of claim 1 wherein the I/O interfaces include any combination of serial ports, parallel ports, USB ports, network interfaces or any other typical PC I/O interface.

5. A method wherein the requirements of real-time constraints from claim 3 are met using features of a preemptive multitasking operating system.

6. The method from claim 5 wherein the operating system features employed are threads, asynchronous I/O and data caching.
